(19) United States
(12) Patent Application Publication
(10) Pub. No.: US 2017/0071805 A1
(43) Pub. Date: Mar. 16, 2017

(54) SYSTEM FOR ASSITANCE IN TRANSITION BETWEEN STANDING AND SITTING AND BETWEEN SITTING AND STANDING

(71) Applicant: LIFE ASSISTANT LTD., Kibbutz Reshafim (IL)

(72) Inventors: Iftah GEVA, Kibbutz Reshafim (IL); Gal GOLDNER, Kibbutz Ginegar (IL)

(73) Assignee: LIFE ASSISTANT LTD., Kibbutz Reshafim (IL)

(21) Appl. No.: 15/123,950

(22) PCT Filed: Mar. 2, 2015
(86) PCT No.: PCT/IL2015/050223

§ 371 Date: Sep. 6, 2016

(30) Foreign Application Priority Data
Mar. 3, 2014 (IL) 231278

(51) Int. Cl. A61G 5/14; A47C 31/00; A61G 7/10; A47C 7/14

(52) U.S. Cl. CPC A61G 5/14; A47C 7/14; A47C 31/008; A61G 7/1021

(57) ABSTRACT

A method for operating an assisting system for the disabled is disclosed. The assisting system includes a cushion, which includes a plurality of cushion chambers. The pressure in the cushion is measured by a pressure sensor. If the measured pressure is found to be above a threshold, a deflation of the cushion follows. Contrarily if the pressure is lower than the threshold, inflation of the cushion follows.

### FIELD OF THE INVENTION

The present invention relates to a system for assistance of a person requiring assistance in transition between standing and sitting and between sitting and standing, more particularly, to a pneumatic system for a system for assistance of a person requiring assistance in transition between standing and sitting and between sitting and standing, including an inflating and deflating air cushion.

### BACKGROUND OF THE INVENTION

U.S. Pat. No. 6,015,471 of Rimington et al. teaches an inflatable lifting cushion having two segments each segment comprising a ring chamber around a central web. The two segments are welded together. An air inlet fitting is attached to one of the segments for simultaneous inflation of the two chambers.

U.S. Pat. No. 6,199,827 also of Rimington et al. teaches an expandable lifting device and valve assemblies for such lifting devices. The lifting device has stack of bags, such four secured together. A valve assembly is mounted on each bag. The valve assemblies automatically ensure sequential inflation of the bags.

U.S. Pat. No. 6,994,112 of Garman teaches a control unit for controlling the supply of compressed air to a plurality of inflatable devices for inflating and for deflating them.

International Patent Application No. PCT/GB2004/002655 also of Garman teaches an apparatus for lifting and lowering persons and objects. The apparatus can also be applied with one inflatable chamber.

U.S. Pat. No. 8,037,560 whose inventor, Goldner, is one of the inventors of the present invention, teaches a portable cushion that is divided into multiple inner chambers, the structure including a base layer, at least two columns of at least two inflatable chambers each disposed on said base layer, a lightweight, portable air pressure generator for supplying air to the cushion, and a hose to connect the cushion to the said air pressure generator, wherein the inflating sequence of the cushion enables one layer of chambers to fully inflate before the subsequent layer of chambers is able to inflate.

FIG. 1a is a perspective view of an embodiment of the prior art portable cushion 90, partially inflated and disposed on the seat of a chair 200.

An air pressure generator 91 is operatively connected to the portable cushion 90 by a hose 92. Control mechanism 93, such as control handle for activating the air pressure generator 91 in order to inflate and, according to some embodiments, deflate portable cushion 90.

FIG. 1b is a rear sectional view of an embodiment of portable cushion 90, fully inflated, having chambers 90a, wherein the chambers 90a are configured into two columns of three chambers each.

Every two neighboring chambers 90a are separated either by an inner vertical wall 90c having horizontal holes 90e, or by an inner horizontal wall 90b, having vertical holes 90d. The horizontal holes 90e and the vertical holes 90d enables air, or other fluid, to flow from one chamber 90a to a neighboring chamber 90a.

### BRIEF SUMMARY EMBODIMENTS OF THE INVENTION

While the prior art teaches the assistance of a person requiring assistance in transition between sitting and standing, and offers systems including inflatable cushions in several different configurations, it lacks a proper means to effectively and safely assist a person requiring assistance in transition between standing and sitting.

The system for assisting a person requiring assistance in transition between standing and sitting and between sitting and standing according to the present invention also enables the serial deflating of the inflating and deflating cushion of air, or a suitable fluid, starting with the most upper chamber down to the lowest chamber, of a series of inflating and deflating chambers vertically connected one above the other.

It is highly important in a product of this type for the supported person to be provided stability even during deflation.

According to the teaching of the present invention there is provided a method of an operation of an assisting system, wherein the assisting system includes a cushion, wherein the cushion includes n-cushion chambers, the method includes the stages of:
checking pressure measured by a pressure sensor; if at the pressure checking stage, the pressure, measured by the pressure sensor, is at least equal to a predetermined value, performing a sub-stage of sequential deflating of the cushion chambers; and if at the pressure checking stage, the pressure, measured by the pressure sensor, is lower than the predetermined value, performing a sub-stage of sequential inflating of the cushion chambers system.

According to another feature of the present invention the sub-stage of sequential deflating of the cushion chambers includes: adjusting a selector of the assisting system for enabling deflating air from a first selected cushion chamber, and deflating air from the first selected chamber; measuring predetermined period of time; and adjusting the selector for enabling deflating air from a second selected cushion chamber, and deflating air from the second selected chamber.

According to another feature of the present invention the sub-stage of sequential deflating of the cushion chambers includes: adjusting a selector of the assisting system for enabling deflating air from a first selected cushion chamber, and deflating air from the first selected cushion chamber; measuring the pressure measured by a pressure sensor; and if the pressure, measured by the pressure sensor, is at most equal to an atmospheric pressure, adjusting the selector for enabling deflating air from a second selected cushion chamber, and deflating air from the second selected chamber.

According to another feature of the present invention the sub-stage of sequential deflating of the cushion chambers further includes: if n is larger than two, measuring predetermined period of time; and adjusting the selector for enabling deflating air from a third selected cushion chamber, and deflating air from the third selected chamber.

According to another feature of the present invention the sub-stage of sequential inflating of the cushion chambers includes: adjusting a selector of the assisting system for enabling inflating a first selected cushion chamber; supplying air from a high pressure source and inflating the first selected cushion chamber; measuring predetermined pressure by the pressure sensor; adjusting the selector of the assisting system for enabling inflating a second selected cushion chamber; and supplying air from the high pressure source and inflating the second selected cushion chamber.

According to another feature of the present invention the sub-stage of sequential inflating of the cushion chambers further includes: if n is larger than two, measuring predetermined period of time; measuring predetermined pressure by the pressure sensor; adjusting the selector for enabling inflating a third selected cushion chamber; and supplying air from the high pressure source and inflating the third selected cushion chamber.

According to another feature of the present invention the method further includes: after performing a sub-stage of sequential deflating of said cushion chambers, activating a control device; and performing a sub-stage of sequential inflating.

According to another feature of the present invention the method further includes: after performing a sub-stage of sequential inflating of said cushion chambers, activating a control device; and performing a sub-stage of sequential deflating.

According to the teaching of the present invention there is provided a method of an operation of an assisting system, wherein the assisting system includes a cushion, wherein the cushion includes n-cushion chambers, the method including the stages of: activating the assisting system; adjusting a selector of the assisting system, for enabling deflating air from all of the n-cushion chambers, and deflating air from all of the cushion chambers; and performing a parallel inflating.

According to the teaching of the present invention there is provided an assisting system for assistance of a person requiring assistance in transition such as between standing and sitting, the assisting system including: a cushion, wherein the cushion includes n-cushion chambers, wherein the n is an integer number, larger than one, wherein the n-cushion chambers are disposed one above the other, and every two subsequent cushion chambers are attached to each other, wherein each one of the n-cushion chambers has a chamber wall and a chamber opening, wherein the chamber walls include no opening that enable a direct movement of fluid between one of the n-cushion chambers to another one of the n-cushion chambers; a selector, wherein the selector includes n-selector openings, wherein each one of the n-selector openings is operatively connected to one, and only to one, of the chamber openings, for enabling a fluid flow from the one chamber opening into the selector; and a selector inlet for enabling a fluid flow into the selector; and a fluid source operatively connected to the inlet, for enabling a fluid flow from the fluid source into the selector.

According to another feature of the present invention the selector is adapted to enable performing a full sequential deflating of the n-cushion chambers, activated by one command signal.

According to another feature of the present invention the selector is adapted to enable performing a partial sequential deflating of the n-cushion chambers, activated by one command signal.

According to another feature of the present invention the selector is adapted to enable performing a deflating of one selected cushion chamber from the n-cushion chambers for each command signal.

According to another feature of the present invention the e selector is adapted to enable performing a parallel inflating of the n-cushion chambers.

According to another feature of the present invention the selector is further adapted to enable performing a full sequential inflating of the n-cushion chambers, activated by one command signal.

According to another feature of the present invention, wherein inside of at least one of the n-cushion chambers there is a porous layer.

According to another feature of the present invention the assisting system further includes: an outer cover, coated the cushion wherein the outer cover is composed of elastic material.

According to another feature of the present invention the assisting system further includes: n-selector tubes, wherein each one of the n-selector tubes is disposed between one of the n-selector openings and one of chamber openings.

According to another feature of the present invention the assisting system further includes: a source tube disposed between the fluid source and the selector inlet; and a pressure sensor located on the source tube.

According to another feature of the present invention the assisting system further includes: a control device; and an electrical wire disposed between the fluid source and the control device.

According to another feature of the present invention the selector further includes: an upper cover wherein the selector openings are located at the upper cover; a front housing having n-front housing slots, wherein the front housing is disposed on the upper cover; a selector inlet located at the front housing; a rear housing having n-rear housing slots, wherein the rear housing is disposed on the upper cover and on the front housing; a seal cylinder mounted inside the front housing and the rear housing, wherein the seal cylinder have a selector cylinder wall, wherein there is n-seal cylinder slots at the selector cylinder wall; and a selector cylinder mounted inside the seal cylinder, wherein the selector cylinder have a selector cylinder wall, having a selector cylinder rear side, and a selector cylinder front side, wherein a selector cylinder rear wall, is disposed on the selector cylinder wall at the selector cylinder rear side, wherein there is a selector cylinder front opening, located at the selector cylinder front side, wherein there are a selector cylinder side opening, and a selector cylinder upper opening, at the selector cylinder wall.

According to another feature of the present invention the selector further includes: a rotational axle, mechanically connected to the selector cylinder; an engine, mechanically connected to the rotational axle; a positioning disc, having a positioning disc concave and a positioning disc projection, the positioning disc is mechanically connected to the rotational axle; and a micro switch having a micro switch spring, at the end of which there is a micro switch wheel, wherein the micro switch wheel is in contact with the positioning disc.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1a is a perspective view of an embodiment of the prior art portable cushion, partially inflated and disposed on the seat of a chair.

FIG. 1b is a rear sectional view of an embodiment of portable cushion, fully inflated, having chambers, wherein the chambers are configured into two columns of three chambers each.

FIG. 2 is a back perspective view schematic illustration of a person seated on a cushion, which is resting on a chair.

FIG. 3a is a front view schematic illustration of an assisting system and of a chair, in accordance with an embodiment of the present invention.

FIG. 3b is an isometric view schematic illustration of an assisting system and of a chair, in accordance with an embodiment of the present invention.

FIG. 4 is an isometric exploded view schematic illustration of an assisting system in accordance with an embodiment of the present invention.

FIG. 5a is a top view schematic illustration of an assisting system in accordance with an embodiment of the present invention, upon which section planes 5b-5b and 5c-5c are marked.

FIG. 5b is a cross sectional view 5b-5b.

FIG. 5c is a cross sectional view 5c-5c.

FIG. 6a is an isometric view schematic illustration of a selector of the assisting system in accordance with an embodiment of the present invention.

FIG. 6b is a front view schematic illustration of a selector of the assisting system in accordance with an embodiment of the present invention, upon which section plane 6c-6c and 6d-6d are marked.

FIG. 6c is a cross sectional view 6c-6c.

FIG. 6d is a cross sectional view 6d-6d.

FIG. 6e is an isometric view schematic illustration of a selector cylinder of the selector of the assisting system in accordance with an embodiment of the present invention.

FIG. 6f is rear view schematic illustration of a selector cylinder of the selector of the assisting system in accordance with an embodiment of the present invention, upon which section plane 6g-6g is marked.

FIG. 6g is a cross sectional view 6g-6g.

FIG. 6h is an isometric view schematic illustration of a seal cylinder of the selector of the assisting system in accordance with an embodiment of the present invention.

FIG. 6i is a side view schematic illustration of the engine of the assisting system and the components that it rotates in accordance with an embodiment of the present invention.

FIG. 6j is a bottom isometric view schematic illustration of an upper cover of the assisting system in accordance with an embodiment of the present invention.

FIG. 6k is a top isometric view schematic illustration of a front housing and of back housing of the assisting system in accordance with an embodiment of the present invention.

FIG. 6l is an isometric view schematic illustration of a micro switch and of a positioning disc of the selector of the assisting system in accordance with an embodiment of the present invention.

FIG. 6m is an isometric exploded view schematic illustration of the selector of the assisting system in accordance with an embodiment of the present invention.

FIG. 6n is an isometric view schematic illustration of a back housing, a seal cylinder, and a selector cylinder of the selector of the assisting system in accordance with an embodiment of the present invention, in four different working modes.

FIG. 7 is an electrical schematic scheme of the assisting system in accordance with an embodiment of the present invention.

FIG. 8a is a flow chart that schematically illustrates a method of an operation of an assisting system in accordance with an embodiment of the present invention.

FIG. 8b is a flow chart that schematically illustrates the method of performing a sub-stage of sequential deflating in accordance with an embodiment of the present invention.

FIG. 8c is a flow chart that schematically illustrates the method of performing a sub-stage of sequential inflating in accordance with an embodiment of the present invention.

FIG. 8d is a flow chart that schematically illustrates the method of performing a parallel inflating in accordance with an embodiment of the present invention.

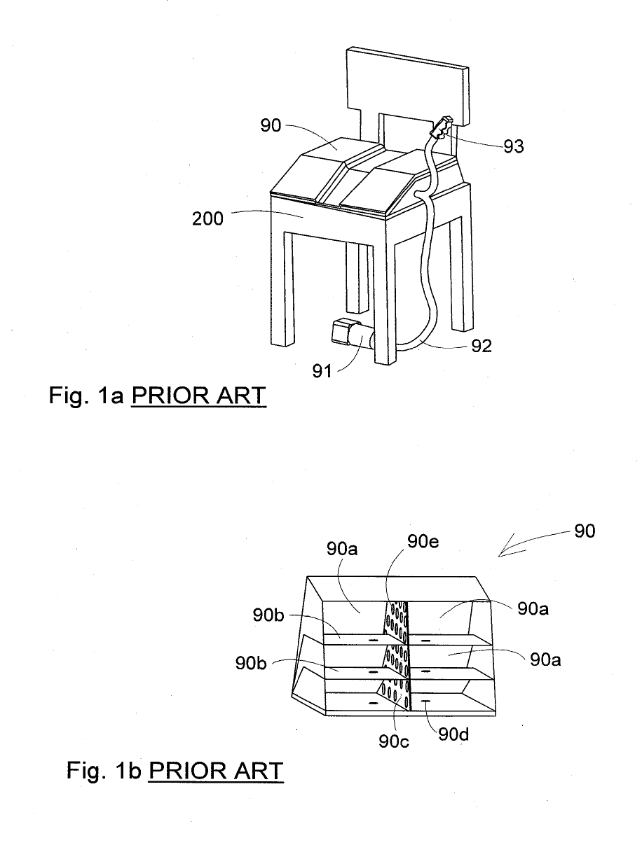

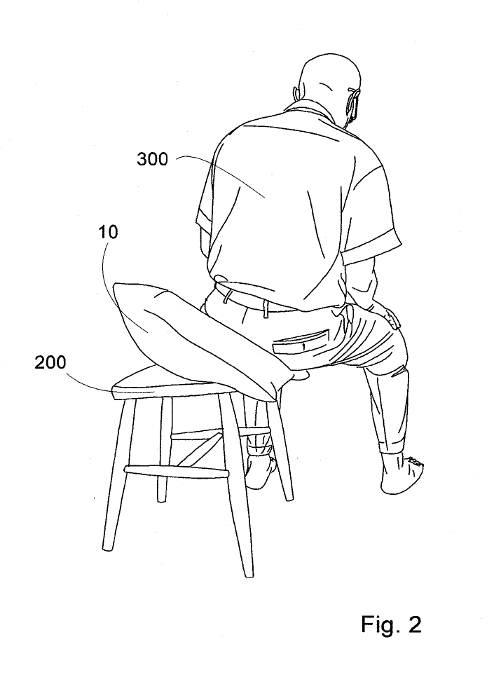

In order to leave no room for doubt, the elements shown in the illustrations of the present patent application in a manner that enables understanding them clearly, and the scales, size relations, and shapes are not in any way limiting their embodiment.

### DETAILED DESCRIPTION OF EMBODIMENTS OF THE INVENTION

To remove any doubt, note that the manner in which the elements of the present invention are described in the illustrations can be highly detailed, however is not in any way limiting the present invention, however is for the purpose of clarification and furthering understanding. The present invention can be implemented in embodiments that differ from the specification given with regard to the illustration.

The present invention is of a pneumatic system for a system for assistance of a person requiring assistance in transition between standing and sitting and between sitting and standing. The principles and operation of a pneumatic system for a system for assistance of a person requiring assistance in transition between standing and sitting and between sitting and standing, according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
10 cushion
10a first cushion chamber
10b second cushion chamber
10c third cushion chamber
10d fourth cushion chamber
10i cushion chamber number i
11 chamber opening
12 chamber wall
13 outer cover
14 porous layer
20 fluid source
30 source tube
31a first selector tube
31b second selector tube
31c third selector tube
31d fourth selector tube
40 selector
40a engine
40b selector inlet
40c positioning disc
40ca positioning disc concave
40cb positioning disc projection
40cc positioning disc pulse angle
40da first selector opening
40db second selector opening
40dc third selector opening
40dd fourth selector opening
40e micro switch
40ea micro switch spring
40eb micro switch wheel
40f outlet
40g front housing
40ga front housing slot
40gb front housing upper side
40h rear housing
40ha rear housing slot
40hb rear housing upper side
40i rear cover
40j selector cylinder
40ja selector cylinder wall
40jb selector cylinder side opening
40jc selector cylinder upper opening
40jd selector cylinder front opening
40je selector cylinder rear opening
40jf selector cylinder front side
40jh selector cylinder front wall
40ji selector cylinder rear wall
40jj selector cylinder partition
40jr selector cylinder rear side
40k seal cylinder
40ka seal cylinder wall
40kb seal cylinder slot
40l upper cover
40la upper cover canal
40lb upper cover bottom side
40m engine pivot
41 adaptor
42 rotational axle
50 electrical wire
52 processor
60 control device
60a push button
70 pressure sensor
90 portable cushion (of the prior art)
90a chamber (of the prior art)
90b inner horizontal wall (of the prior art)
90c an inner vertical wall (of the prior art)
90d vertical hole (of the prior art)
90e horizontal hole (of the prior art)
91 air pressure generator (of the prior art)
92 hose (of the prior art)
93 control mechanism (of the prior art)
100 assisting system
200 chair
300 person
l1 inflation sequence activation switch
l2 micro switch
l4 deflation sequence activation switch
B01 first latching relay
B02 first signal stabilizer
B03 inflation meter
B04 second signal stabilizer
B05 second latching relay
B06 third signal stabilizer
B07 first ‘OR’ component
B08 third latching relay
B09 second ‘OR’ component
B10 fourth signal stabilizer
B11 inflating timer
B12 inflating counter
B13 fourth latching relay
B14 first ‘AND’ component
B15 fifth latching relay
B16 second ‘AND’ component
M1 software component

Hereinafter, embodiments of the present invention are explained in detail by referring to the drawings.

FIG. 2 is a back perspective view schematic illustration of a person 300 seated on a cushion 10, which is resting on a chair 200.

If the cushion 10 is inflated and contains air at a sufficient pressure, it will support a person 300 when suspended at a distance upward from the chair 200. After cushion 10 is deflated, person 300 will be seated on the chair 200. However, if cushion 10 is composed as a single chamber, the larger the volume of this chamber, and particularly the larger its thickness (a dimension not shown in the present illustration), the greater the risk that during deflation the cushion will obtain an asymmetric form, particularly if person 300 is not seated on its center. This could result in tilting and falling off during the deflation process. This problem is solved, according to the present invention, as will be shown in the subsequent illustrations, by the division of a cushion 10 into several chambers, disposed one above the other, while each chamber has a small volume relative to the total volume of cushion 10, and the thickness of every such chamber is smaller than the total thickness of cushion 10.

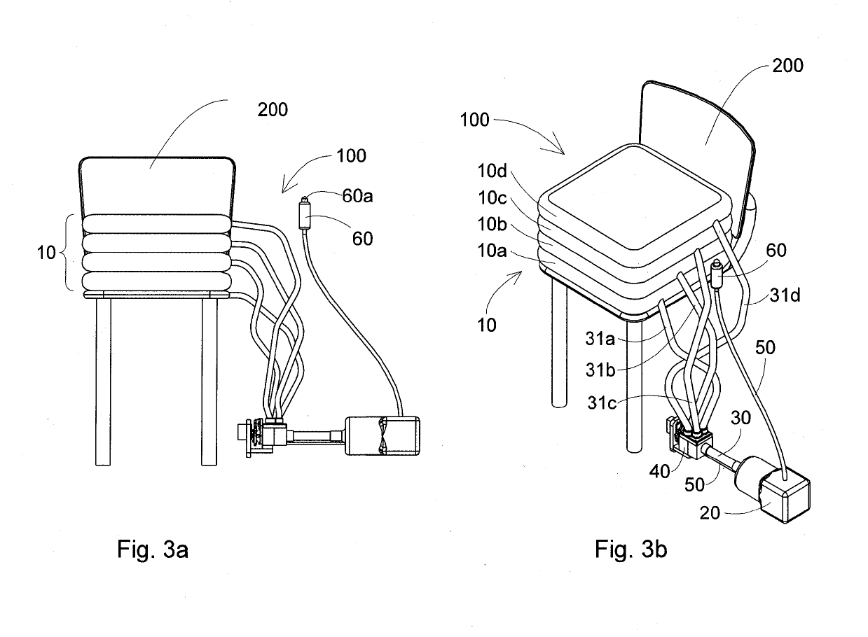

FIG. 3a is a front view schematic illustration of an assisting system 100 and of a chair 200, in accordance with an embodiment of the present invention.

A cushion 10 of the assisting system 100 rests upon the chair 200. The start activation command of the assisting system 100, both for inflating and for deflating, is initiated by manual pressing of a push button 60a of a control device 60.

However, according to the present invention, other means to initiate a start activation command are also possible.

FIG. 3b is an isometric view schematic illustration of an assisting system 100 and of a chair 200, in accordance with an embodiment of the present invention.

The cushion 10, of the assisting system 100 rests upon the chair 200. The cushion 10 includes several chambers, or in other words n-cushion chambers, wherein n is an integer number, larger than one, wherein n equals four, in the case shown in the present illustration, however according to the present invention, other numbers larger than one are also possible.

The chambers of the cushion were marked from the bottom upward as a first cushion chamber 10a, a second cushion chamber 10b, a third cushion chamber 10c, and a fourth cushion chamber 10d, and they are mechanically connected to each other as shown in the present illustration.

According to an embodiment of the present invention, there is no possibility for direct movement of air between one cushion chamber to another cushion chamber.

Note: use of terminology such as up, down, above, below, etc. is for the purpose of understanding the invention with regard to the illustrations describing the system or its components in this or any other orientation, however this is in no way limiting the present invention and system from using other orientation, such as during packing and transport from one place to another.

The assisting system 100 also includes a fluid source 20, which is designated to provide a fluid, such as air, at a suitable flow rate and pressure for the inflation of the cushion 10. The fluid source 20 can be, for example, bellows, an electric compressor connected to grid power or an electric battery, or any other device that can provide the necessary flow rate of fluid, at the necessary pressure.

The fluid source 20 is, mechanically and electrically, connected to a selector 40 by one or more source tubes 30, designated to enabled the flow of fluid from the fluid source 20 to the selector 40 and by one or more electrical wires 50 to enable the possibility of flow of electricity for the purpose of activation and control of the assisting system 100.

The selector 40 is connected by means of one or more first selector tubes 31a to the first cushion chamber 10a, one or more second selector tubes 31b to the second cushion chamber 10b, one or more third selector tubes 31c to the third cushion chamber 10c, and one or more fourth selector tubes 31d to the fourth cushion chamber 10d.

Of course, when the cushion 10 includes a different quantity of cushion chambers, the assisting system 100 will include a suitable corresponding quantity of selector tubes.

A control device 60 is electrically connected to the fluid source 20 be one or more electrical wires 50, for the purpose of activating the system.

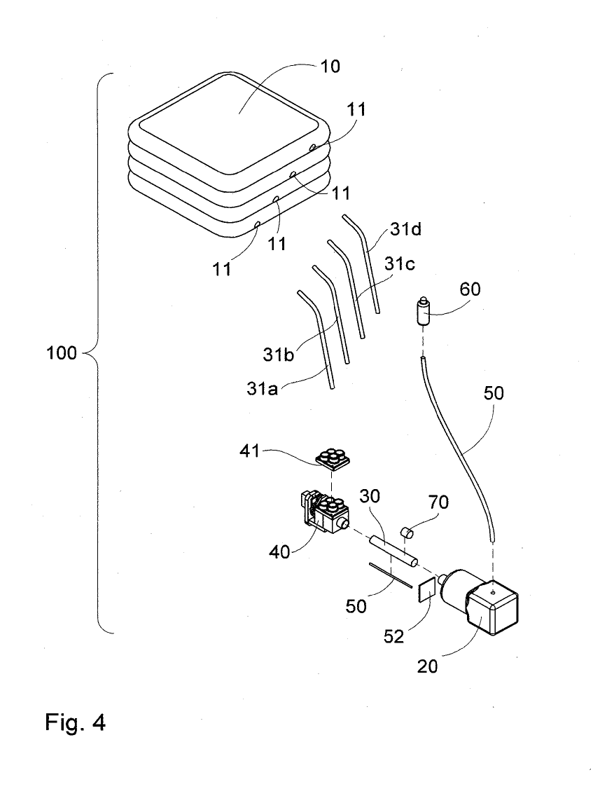

FIG. 4 is an isometric exploded view schematic illustration of an assisting system 100 in accordance with an embodiment of the present invention.

The assisting system 100 includes main mechanical components the cushion 10, having chamber openings 11, fluid source 20, the selector 40, and the control device 60. These components are connected, as shown in FIG. 3b, by means of the electrical wires 50, the source tube 30, the first selector tube 31a, the second selector tube 31b, the third selector tube 31c, and the fourth selector tube 31d.

A processor 52 is also electrically and mechanically connected to the electrical wires 50.

The assisting system 100 can also include an adaptor 41 designated to ensure a good connection of these selector tubes to the selector 40.

The assisting system 100 includes also at least one pressure sensor 70, located on the source tube 30, which is connected between the fluid source 20 and the selector 40.

According to the present invention, the first selector tube 31a, the second selector tube 31b, the third selector tube 31c, and the fourth selector tube 31d can be of various lengths, including short lengths of just a few centimeters enabling positioning selector 40 in very close proximity to cushion 10.

According to the present invention, the adaptor 41 can also be connected directly to the chamber openings 11.

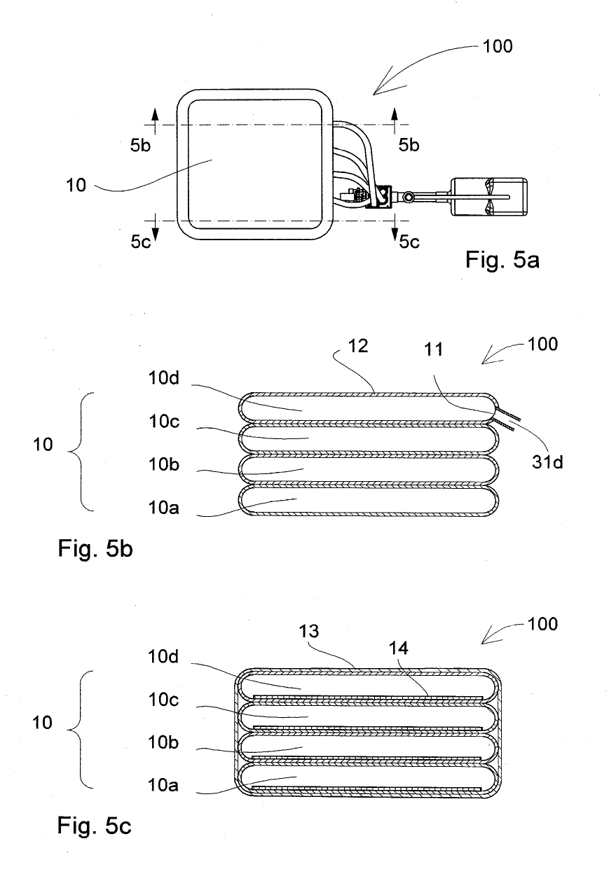

FIG. 5a is a top view schematic illustration of an assisting system 100 in accordance with an embodiment of the present invention, upon which section planes 5b-5b and 5c-5c are marked.

In this view cushion 10 has a substantially square shape. This shape is not the only possible shape, however it is a good shape to ensure that during inflation, cushion 10 does not take on a spatial shape similar to a sphere.

FIG. 5b is a cross sectional view 5b-5b.

Cushion 10 is shown, including four chambers, the first cushion chamber 10a, the second cushion chamber 10b, the third cushion chamber 10c, and the fourth cushion chamber 10d, however other quantities of chambers are possible, as long as they are larger than one.

The chambers are disposed one above the other, and every two subsequent chambers are attached to each other. Each chamber has a chamber wall 12. Every two subsequent chambers can have a joint chamber wall 12 segment, serving as a part of each one's chamber wall 12, or they can have no such joint chamber wall 12 segment, as shown in the present illustration.

Each chamber has a chamber opening 11. The present section shows the chamber opening 11 of the fourth cushion chamber 10d, which is connected to the fourth selector tube 31d.

The chamber walls 12 include no chamber opening 11 and no other hole connected to a selector tube, namely no entrance of air is allowed to any chamber and no exit of air is allowed from any chamber by means other than a selector tube. This enables pressured inflation, for example, of the first cushion chamber 10a, without air flowing from this chamber into the second cushion chamber 10b.

The plurality of chambers that comprise cushion 10 may be constructed of any type of material that is flexible, thin, lightweight, and air-sealable. Any material that includes these properties may be suitable for the present invention, including, inter alia, plastic-coated fabrics. In some embodiments, the materials used to construct the inner and outer surfaces are the same, while in other embodiments the inner and outer surfaces may be constructed of dissimilar materials. It is understood that other materials may be used without departing from the scope of the invention.

FIG. 5c is a cross sectional view 5c-5c.

According to an embodiment of the present invention cushion 10 is coated with an outer cover 13 composed of elastic material, such as lycra fabric, which in its relaxed state has an internal volume which is smaller than the total volume of all of the chamber walls 12 combined. During inflation of the cushion 10, the outer cover 13 is stretched and applies pressure to the cushion 10. If deflation of air from the cushion 10 is possible, the pressure applied will now be atmospheric pressure as well as the pressure applied by the outer cover 13, which on one hand expedites the emptying process and on the other hand ensures that the cushion 10, empty of air, will take up minimal space.

According to an embodiment of the present invention, in each of the first cushion chamber 10a, the second cushion chamber 10b, the third cushion chamber 10c, and the fourth cushion chamber 10d, there is a porous layer 14 enabling the passage of air through it in any direction. This is necessary so that during deflation, due to suction, there will not be any situation in which the walls of a chamber cling forcefully to each other such that air is trapped in the chamber and the chamber cannot be fully deflated.

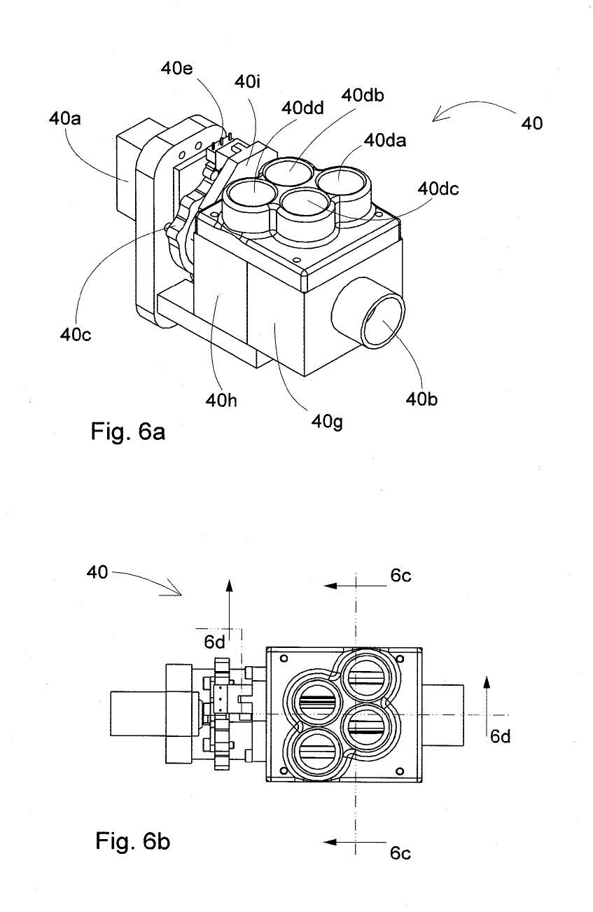

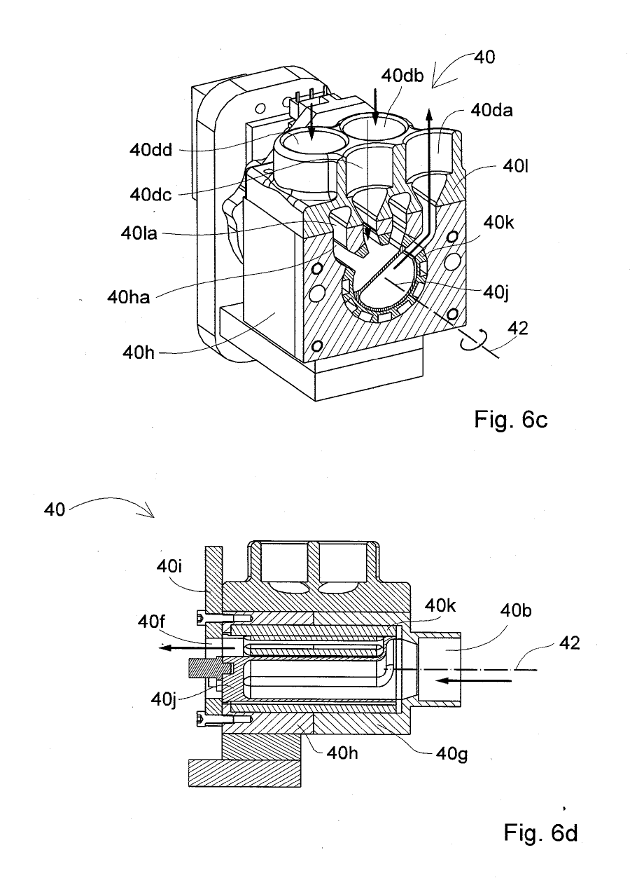

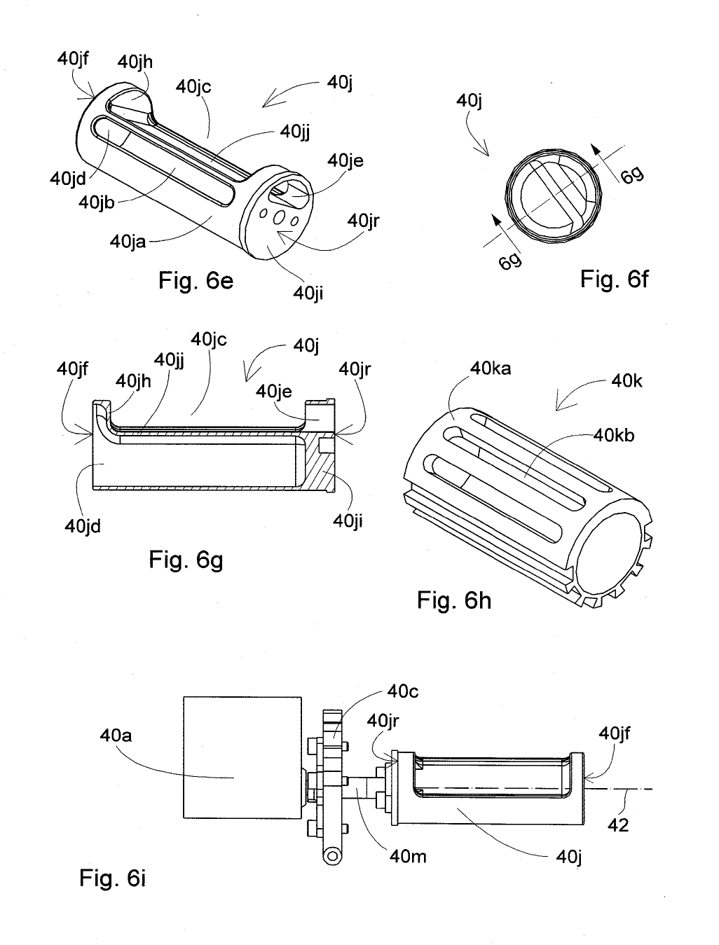

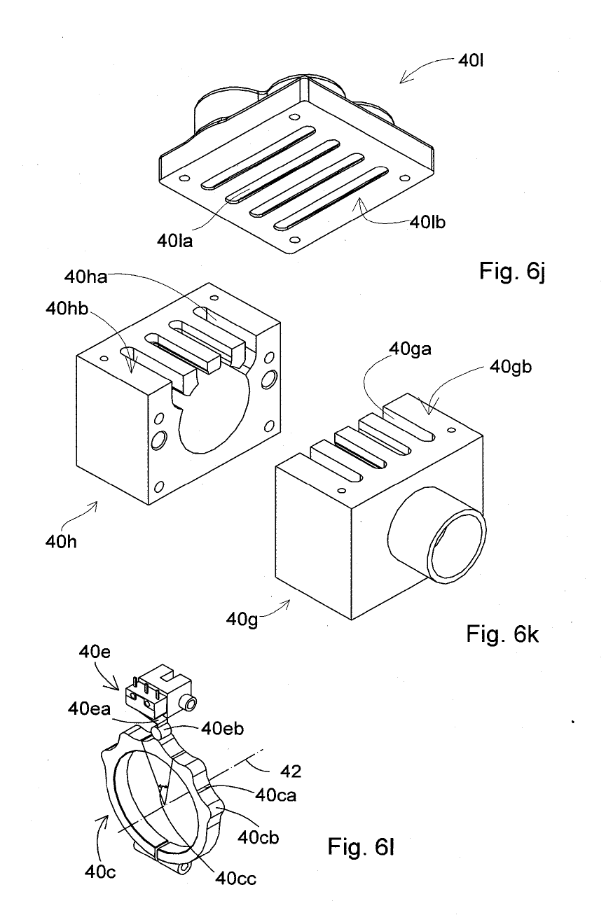

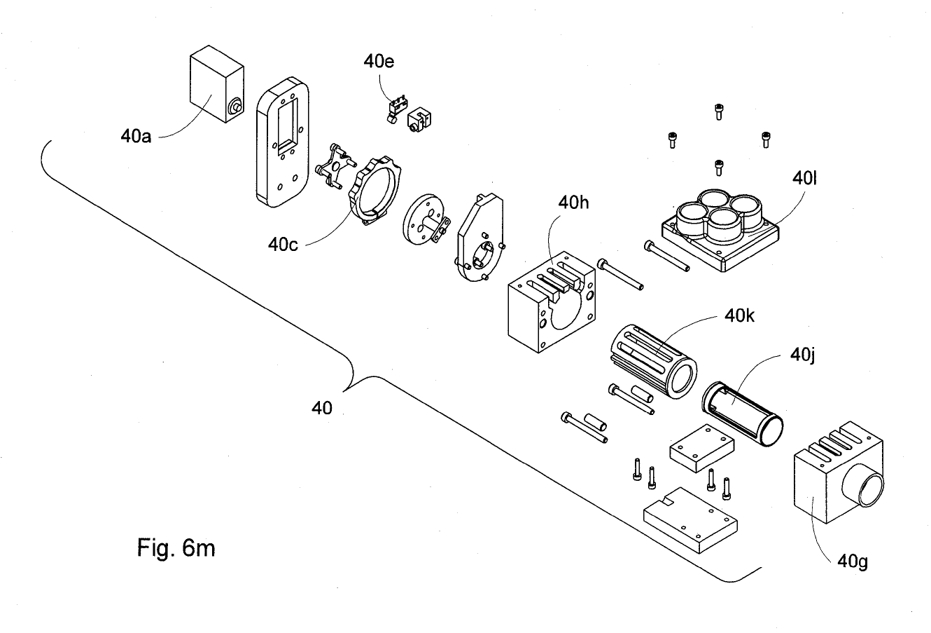

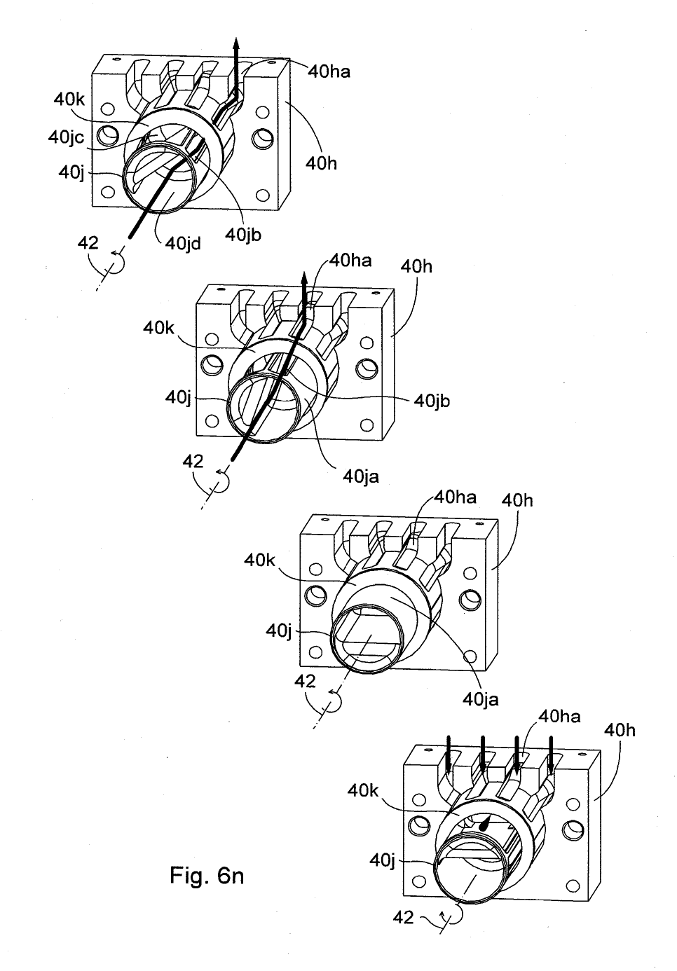

FIG. 6a is an isometric view schematic illustration of a selector 40 of the assisting system 100 in accordance with an embodiment of the present invention.

The selector 40 is adapted to enable the routing of air, or another fluid, at an inflating stage, from the fluid source 20 (not shown in the present invention), to the cushion chambers 10a-10i (not shown in the present invention), in each of the following possible methods:
Simultaneous inflation of all cushions chambers, at once.
Sequential inflation of the cushion chambers, for example from the bottom chamber to the top chamber.
Automatic sequential inflation of the chamber cushions according to pressure, time, or any other selected parameter, which initiates the inflation of the next cushion in the series.
Inflation of several of the cushion chambers according to preselection.
Inflation of each cushion individually and not serially (namely, a single command signal for inflation of a single chamber, and inflation of an additional chamber requires an additional command signal).

The selector 40 is adapted to enable, at a deflating stage, performance of each of the following possibilities:
Parallel deflating, namely simultaneously deflating the entire cushion chambers at once.
Sequential deflating, namely deflating the cushion chambers in a predefined order, namely starting with the top cushion chamber down to the bottom cushion chamber.
Sequential deflating of the cushion chambers, one after the other, automatically, according to pressure, time, or any other preselected parameter to initiate the deflation of the next cushion chamber in the series.
Deflating several of the cushion chambers according to preselection.
Deflating each cushion individually and not serially (namely, a single command signal for deflation of a single chamber, and deflation of an additional chamber requires an additional command signal).

The selector 40 has housing which can be, as shown in the present illustration, composed of a front housing 40g and a rear housing 40h, and closed on its rear end by a rear cover 40i, however according to another embodiment of the present invention the front housing 40g and the back housing 40h can be composed as a single piece.

The selector 40 has a selector inlet 40b through which air, or another fluid, flows from the fluid source 20 (not shown in the present illustration), for the purpose of inflating the chambers of the cushion 10.

The air is guided by the internal mechanism of the selector 40 to one, or more than one simultaneously, of the first selector opening 40da, the second selector opening 40db, the third selector opening 40dc, and the fourth selector opening 40dd; connected respectively to the first selector tube 31a, the second selector tube 31b, the third selector tube 31c, and the fourth selector tube 31d; or to all at once, the selector tubes 31a, 31b, 31c, and 31d, (not shown in the present illustration).

The internal mechanism, that is to be described in detail subsequently, gains rotational movement, serving to guide the air in the desired direction, from an engine 40a. The movement is also controlled by means of a positioning disc 40c, and a micro switch 40e.

The unique structure of the selector 40, its method of action and its method of control enable it to achieve vital performance features which are unique to the assisting system 100 according to the present invention, also including:

Cessation of the flow of air into a chamber, during the process of inflation, and cessation of the flow of air from a chamber, during the process of deflation, enabling maximal convenience for the user or use of the product as a therapeutic product.

The choice of whether to inflate all chambers at once or to deflate all chambers at once, during inflation prior to seating and during deflation prior to porting, for the purpose of complete inflation and convenient folding in a faster procedure than when this is done in procedures including sequential inflation or deflation of the chambers, one after the other.

Enabling the inflation of all chambers of the cushion in a process which controls the pressure in the chambers by means of only one pressure sensor, without the need for a pressure sensor in every chamber, thus lowering the cost of the product and simplifying the manufacturing and assembly processes.

Enabling serial emptying of the chambers, one after the other is enabled by receiving an indication of air pressure in each chamber, or by means of a timer.

The option for use of a remote controller with one button for inflation or deflation—this can be done by use of the selector controller, thus making the controller convenient and not confusing for disabled users.

The option for deflation of the air from the cushion—for the purpose of fast folding of the cushion to minimal size. In order to grant this option, between the air-impervious fabric layers there should be a layer of porous fabric to prevent a vacuum lock during suction of air from the chambers.

FIG. 6b is a front view schematic illustration of a selector 40 of the assisting system 100 in accordance with an embodiment of the present invention, upon which section plane 6c-6c and 6d-6d are marked.

FIG. 6c is a cross sectional view 6c-6c.

The section also passes through the back housing 40h. In the back housing 40h there are four back housing slots 40ha and in upper cover 40l there are four upper cover canals 40la, all for the purpose of enabling the flow of air to and from the first selector opening 40da, the second selector opening 40db, the third selector opening 40dc, and the fourth selector opening 40dd.

The air flow regimen within the selector 40 is determined according to the orientation of the rotational angles of the selector cylinder 40j and of the seal cylinder 40k relative to rotational axle 42.

In the specific state shown in the present illustration, the flow of air outward from the selector 40 through the first selector opening 40da is for the purpose of inflation of the first cushion chamber 10a (not shown in the present drawing), and flow of air inward is enabled to the selector 40 through the second selector opening 40db the third selector opening 40dc and the fourth selector opening 40dd, for_the purpose of keeping the second cushion chamber 10b, the third cushion chamber 10c, and the fourth cushion chamber 10d empty of air, and at the local environmental pressure (namely the chambers that are not filled at this stage, or have not yet been filled with air or any other fluid, remain open to the environment).

FIG. 6d is a cross sectional view 6d-6d.

In the back cover 40i there is an outlet 40f through which air can exit to the environment, and a selector inlet 40b through which air from the fluid source 20 (not shown in the present drawing) can enter, all depending upon the rotational orientation of the selector cylinder 40j and the seal cylinder 40k relative to rotational axle 42.

These rotational orientations determine the states of the selector cylinder 40j and the seal cylinder 40k relative to the front housing 40g and the back housing 40h and also relative to the selector inlet 40b and the outlet 40f, thus affecting the possibilities for air flow.

FIG. 6e is an isometric view schematic illustration of a selector cylinder 40j of the selector 40 of the assisting system 100 in accordance with an embodiment of the present invention.

The selector cylinder 40j has a selector cylinder wall 40ja, a selector cylinder front side 40jf, and a selector cylinder rear side 40jr. Within the selector cylinder 40j, there is a selector cylinder partition 40jj. Within selector cylinder wall 40ja, there is a selector cylinder side opening 40jb on one side of the selector cylinder partition 40jj and a selector cylinder upper opening 40jc on the other side of the selector cylinder partition 40jj.

Selector cylinder front side 40jf has a selector cylinder front opening 40jd and a selector cylinder front wall 40jh. Selector cylinder rear side 40jr has a selector cylinder rear opening 40je and a selector cylinder rear wall 40ji.

Air entering the selector cylinder 40j through the selector cylinder front opening 40jd can exit through the selector cylinder side opening 40jb. Air entering the selector cylinder 40j through the selector cylinder upper opening 40jc can exit through the selector cylinder rear opening 40je.

FIG. 6f is rear view schematic illustration of a selector cylinder 40j of the selector 40 of the assisting system 100 in accordance with an embodiment of the present invention, upon which section plane 6g-6g is marked.

FIG. 6g is a cross sectional view 6g-6g.

The present illustration shows that the selector cylinder front side 40jf, the selector cylinder front wall 40jh and the selector cylinder front opening 40jd are disposed on two different sides of the selector cylinder partition 40jj, and also that the selector cylinder rear side 40jr, the selector cylinder rear opening 40je and the selector cylinder rear wall 40ji are disposed on two different sides of the selector cylinder partition 40jj.

The selector cylinder upper opening 40jc is a relatively large opening, and its area can be practically of an order of magnitude of one third of the area of the selector cylinder wall 40ja.

FIG. 6h is an isometric view schematic illustration of a seal cylinder 40k of the selector 40 of the assisting system 100 in accordance with an embodiment of the present invention.

The seal cylinder 40k has a seal cylinder wall 40ka which has a suitable number of seal cylinder slots 40kb, four in the configuration shown in the present illustration, three of which are shown in the present illustration.

The seal cylinder wall 40ka prevents undesired flow of air or any other fluid, if such is used, within the selector 40 (not shown in the present drawing) and it enables the preservation of high pressure for a long duration of time within the cushion 10 (not shown in the present drawing).

The seal cylinder wall 40ka is composed of material suitable to be designated as a seal, for example akulon, and it can be attached to the front housing 40g, to the back housing 40h (both not shown in the present drawing), or to both, for example by means of silicon adhesive.

FIG. 6i is a side view schematic illustration of the engine 40a of the assisting system 100 and the components that it rotates in accordance with an embodiment of the present invention.

Engine 40a, using an engine pivot 40m, rotates, as necessary, the positioning disc 40c and the selector cylinder 40j, to which it is mechanically connected, around the rotational axle 42.

FIG. 6j is a bottom isometric view schematic illustration of an upper cover 40l of the assisting system 100 in accordance with an embodiment of the present invention.

The upper cover bottom side 40lb has several upper cover canals 40la, four in the case shown in the present illustration, through each of which air can flow.

FIG. 6k is a top isometric view schematic illustration of a front housing 40g and of back housing 40h of the assisting system 100 in accordance with an embodiment of the present invention.

The front housing upper side 40gb has several front housing slots 40ga, four in the case shown in the present illustration. The back housing upper side 40hb also has the same number of back housing slots 40ha.

Every front housing slot 40ga is an extension of a back housing slot 40ha, and air, or a suitable fluid, can flow along them and through them, and reach or flow to an upper cover canal 40la (shown in FIG. 6i).

FIG. 6l is an isometric view schematic illustration of a micro switch 40e and of a positioning disc 40c of the selector 40 of the assisting system 100 in accordance with an embodiment of the present invention.

The positioning disc 40c has positioning disc concaves 40ca, and on each side of a positioning disc concave 40ca is a positioning disc projection 40cb.

The micro switch 40e has a micro switch spring 40ea, at the end of which there is a micro switch wheel 40eb. When the positioning disc 40c rotates around rotational axle 42, the micro switch wheel 40eb applies altering cyclical forces upon the micro switch spring 40ea, and thus can differentiate between every positioning disc pulse angle 40cc and accordingly transfer data to the processor 52 (not shown in the present drawing, shown in FIG. 4).

FIG. 6m is an isometric exploded view schematic illustration of the selector 40 of the assisting system 100 in accordance with an embodiment of the present invention.

The illustration shows several numbered vital components of the selector 40, which are: the front housing 40g, the seal cylinder 40k, the selector cylinder 40j, the back housing 40h, the upper cover 40l, the positioning disc 40c, the micro switch 40e, and the engine 40a.

FIG. 6n is an isometric view schematic illustration of a back housing 40h, a seal cylinder 40k, and a selector cylinder 40j of the selector 40 of the assisting system 100 in accordance with an embodiment of the present invention, in four different working modes.

In order to facilitate the understanding of the process, part of the selector cylinder 40j has been removed from the seal cylinder 40k. In the state shown in the top part of the illustration, the state of rotation around the rotational axle 42 poses the selector cylinder side opening 40jb facing the rightmost back housing slot 40ha. In this state, pressured air that enters the selector cylinder 40j through the selector cylinder front opening 40jd flows through the first selector opening 40da (not shown in the present drawing), and afterwards through the first selector tube 31a (not shown in the present drawing) to inflate the first cushion chamber 10a (not shown in the present drawing).

In this state, if any external pressure is applied to any one of the other three cushion chambers, the air from them will flow through the selector cylinder upper opening 40jc into the selector cylinder 40j, and from there outward to the atmosphere.

If the selector tubes are connected in a different order to the cushion chambers, for example, the first selector tube 31a is connected to the fourth cushion chamber 10d, the fourth cushion chamber 10d will be inflate.

In the state shown in the second part from the top of the present illustration, the selector cylinder 40j has performed an additional rotational segment, determined by the positioning disc 40c (not shown in the present drawing), and the angular size of which is equal to the positioning disc pulse angle 40cc, which is pressing at a suitable state on the micro switch 40e. In this state, the selector cylinder side opening 40jb is facing the second back housing slot 40ha, and an additional cushion chamber, the second cushion chamber 10b (not shown in the present drawing), will be inflated.

The cessation of inflation of each cushion chamber 10a is completed when the pressure sensor 70 (not shown in the present drawing) detects a higher pressure than a predetermined pressure. Every cessation of inflation starts an additional rotational segment of the selector cylinder 40j. In this state, the selector cylinder wall 40ja blocks the first back housing slot 40ha and prevents the pressured air contained in the first cushion chamber 10a from being released.

Namely, this is a sequential process of inflation of the cushion chambers, while according to the configuration of connections as described so far, the order of inflation will be with the first cushion chamber 10a, which is the bottom most chamber first, and the fourth cushion chamber 10d, which is at the topmost, last.

A different connection of the selector tubes to the cushion chambers will result in a different order of inflation. As far as the disabled user's convenience is concerned, there is a preference towards an order of inflation starting from the bottom cushion chamber and ending with the top cushion chamber.

In the state shown in third part from the top of the present illustration, the selector cylinder 40j has continued rotating around the rotational axle 42, counterclockwise in the orientation shown in the present illustration, to a point in which the selector cylinder wall 40ja blocks possible passage of air between the selector cylinder 40j and each one of all four back housing slots 40ha.

Note that the present illustrations include no descriptions of the front housing 40g or of the front housing slots 40ga. For the purpose of simplifying the description, however, wherever the flow of air is possible or impossible through a back housing slot 40ha, it will be respectively possible or impossible as well through the corresponding front housing slot 40ga, as one is an extension of the other.

The state shown in the lower part from the bottom of the present illustration describes a completion of rotation of approximately 180 degrees back in an opposite direction to the direction of the previous rotation around the rotational axle 42. In this state, the flow of air is possible through every one of the back housing slots 40ha, so that if the air pressure in any or all of the cushion chambers is higher than atmospheric pressure, air from the chambers will flow out into the atmosphere.

During rotation of the selector cylinder 40j in the state described immediately above, the back housing slots 40ha are exposed one after the other. According to one method of operation, this exposure is done gradually, while after each exposure, the rotation stops for a predetermined period, suitable for deflation of one cushion chamber.

Serial deflation of all of the cushion chambers is performed this way. This serial deflation is suitable for the deflation of the cushion 10 (not shown in the present drawing) when a disabled user is seated upon it. The preferred order of deflation in this case is starting at the top and ending at the bottom. According to a second method of operation, the entire rotation described is performed without any cessation, so that the exposure is almost simultaneous, enabling simultaneous deflation of all of the cushion chambers of the cushion 10. This method of operation is suitable when it is necessary to deflate the cushion 10 while it is supporting no one, for example for the purpose of packing.

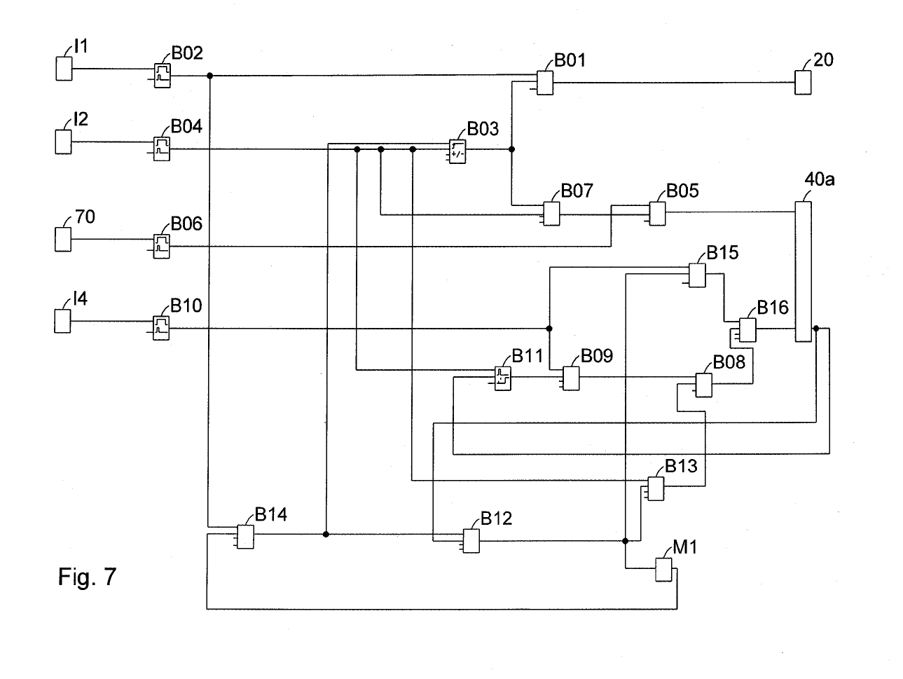

FIG. 7 is an electrical schematic scheme of the assisting system 100 in accordance with an embodiment of the present invention.

Operation of the assisting system 100 for the purpose of inflation starts when a command signal is received from an inflation sequence activation switch l1 (this switch can be within the control device 60).

If the inflation meter B03 is at a gauge level of zero, the inflation process will start such that the fluid source 20 will start working as a result of the first latching relay B01 switching states. In this state, receiving an additional command signal from the inflation sequence activation switch l1 or deflation sequence activation switch l4, will cause no response.

While the fluid source 20 is activated, the pressure sensor 70 continuously senses the pressure. When the pressure reaches a predetermined level, a command signal is received from the pressure sensor 70 for the rotation of the engine 40a in the direction of inflation, thanks to changing the state of the second latching relay B05.

The engine 40a will be activated until the second latching relay B05 receives a command signal from the micro switch l2 to return to the previous state, namely, in which the engine 40a is not working.

The command signal from the micro switch l2 increases the inflation meter B03 by one digit (for example from 2 to 3).

This occurs until the inflation meter B03 reaches a predetermined level (according to the number of chambers), at this stage the fluid source 20 will be switched off, and the inflation process will be completed.

Activation of the assisting system 100 for the purpose of deflation starts when a command signal is received from the deflation sequence activation switch l4 (this switch can be within the control device 60).

The command signal causes rotation of the engine 40a in an opposite direction to that which is necessary for the inflation stage, a state that is a result of the first latching relay B01 changing states.

The engine 40a will be activated until the first latching relay B01 receives an additional command signal from the micro switch l2, to return to its previous state.

When the engine 40a starts rotating, the inflating counter B12 will go up by one digit (such as from 2 to 3). As long as the number in the inflating counter B12 does not exceed the predetermined number, the deflation process will continue. When the number reaches the predetermined number, the deflation process is completed.

As noted, when the number in the inflating counter B12 is lower than the predetermined number, the inflating timer B11 will start working for a predetermined period of time, at the end of which engine 40a will start working in the same manner as described for the beginning of the deflation process which starts with a signal received from the deflation sequence activation switch l4.

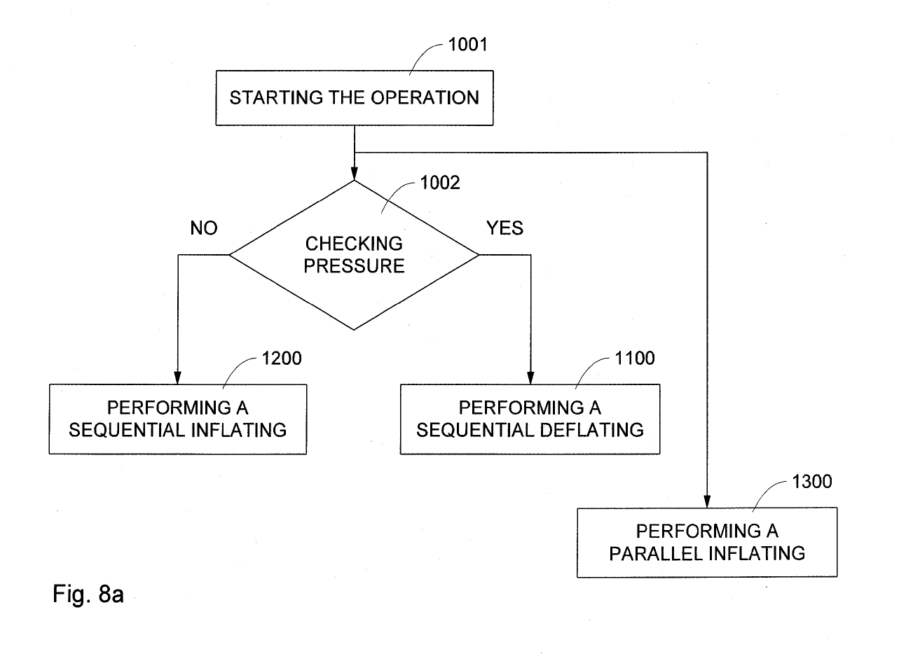

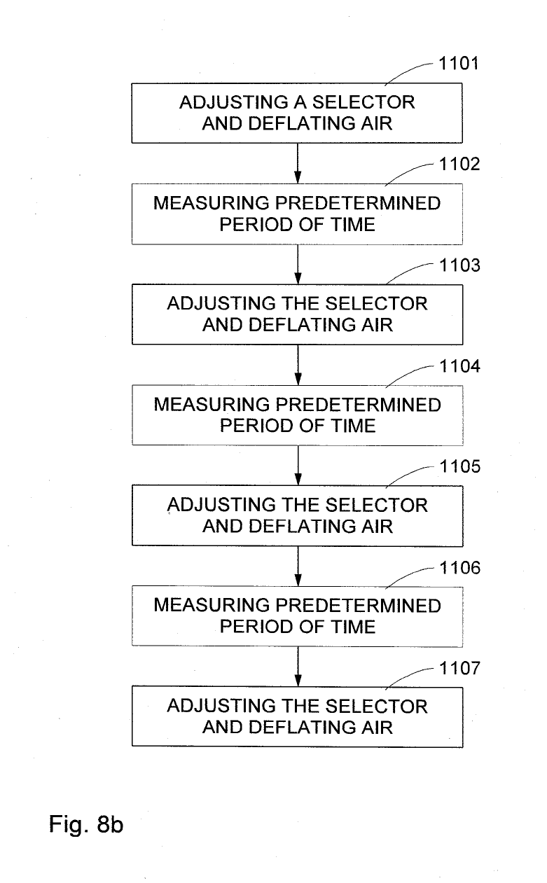

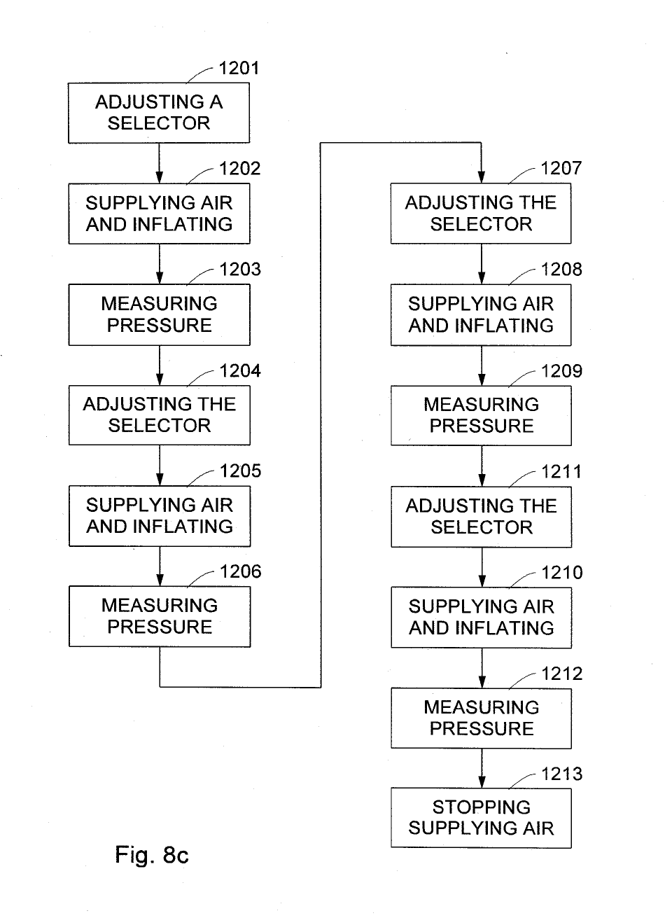

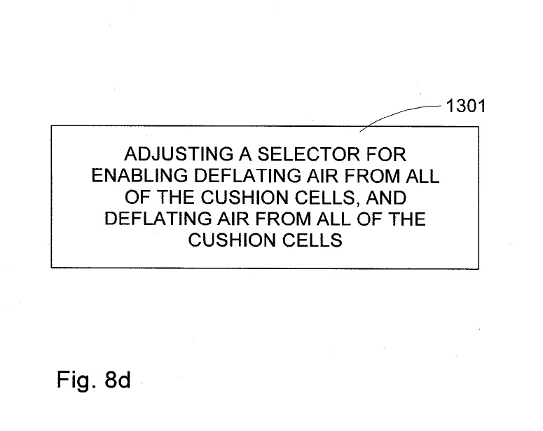

FIG. 8a is a flow chart that schematically illustrates a method of an operation of an assisting system in accordance with an embodiment of the present invention.

The method includes the main stages of:
starting the operation of a assisting system (stage 1001); activation can be performed by means of a short manual press on the push button of the control device of the assisting system, however according to the present invention, it can be performed by other means as well.
checking if the pressure measured by a pressure sensor is higher than a predetermined value (stage 1002);
if the answer is ‘Yes’ performing a sequential deflating (stage 1100);
if the answer is ‘No’ performing a sequential inflating (stage 1200);
in a case in which the activation is performed by means of a manual press longer than a predetermined period of time on the push button of the control device of the assisting system, or by means of any other suitable method of activation, performing a parallel inflating (stage 1300).

As used herein the specification and in the claims section that follows, the terms sequential deflating, sequential inflating, and the like substantially refer to deflating and inflating the cushion chambers of the cushion of the assisting system, in a sequential time order.

The sequential deflating and the sequential inflating can be fully sequential in which all of the cushion chambers are inflated or deflated, or partially sequential in which not all of the cushion chambers are inflated or deflated.

As used herein the specification and in the claims section that follows, the term parallel inflating, and the like substantially refer to inflating the cushion chambers of the cushion of the assisting system at the same period of time.

FIG. 8b is a flow chart that schematically illustrates the method of performing a sub-stage of a sequential deflating in accordance with an embodiment of the present invention.

The method includes the stages of:
adjusting a selector for enabling deflating air from a fourth cushion chamber, which is the upper cushion chamber of a cushion of the assisting system, and deflating air from the fourth cushion chamber (stage 1101);
measuring predetermined period of time (stage 1102);
adjusting the selector for enabling deflating air from a third cushion chamber of the cushion of the assisting system, and deflating air from the third cushion chamber (stage 1103);
measuring a predetermined period of time (stage 1104);
adjusting the selector for enabling deflating air from a second cushion chamber of the cushion of the assisting system, and deflating air from the second cushion chamber (stage 1105);
measuring a predetermined period of time (stage 1106);
adjusting the selector for enabling deflating air from a first cushion chamber the lower cushion chamber of the cushion of the assisting system, and deflating air from the first cushion chamber (stage 1107).

In a case in which the cushion of the assisting system includes a number other than four cushion chambers, the repetition of the series of steps will be carried out the necessary number of times.

FIG. 8c is a flow chart that schematically illustrates the method of performing a sub-stage of sequential inflating in accordance with an embodiment of the present invention.

The method includes the stages of:
adjusting the selector for enabling inflating the first cushion chamber which is the bottom most of the cushion chambers of the cushion of the assisting system, (stage 1201);
supplying air from a high pressure source and inflating the first cushion chamber, (stage 1202);
measuring predetermined pressure by a pressure sensor (stage 1203);
adjusting the selector for enabling inflating the second cushion chamber of the cushion of the assisting system (stage 1204);
supplying air from a high pressure source and inflating the second cushion chamber, (stage 1205);
measuring a predetermined pressure by means of a pressure sensor (stage 1206);
adjusting the selector for enabling inflating the third cushion chamber of the cushion of the assisting system (stage 1207);
supplying air from a high pressure source and inflating the third cushion chamber, (stage 1208);
measuring predetermined pressure by a pressure sensor (stage 1209);
adjusting the selector for enabling inflating the fourth cushion chamber, which is the topmost cushion chamber of the cushion of the assisting system, (stage 1210);
supplying air from a high pressure source and inflating the fourth cushion chamber (stage 1211);
measuring a predetermined pressure by means of a pressure sensor (stage 1212);
stopping supplying air (stage 1213).

FIG. 8d is a flow chart that schematically illustrates the method of performing a parallel inflating in accordance with an embodiment of the present invention.

The method includes the stages of:
adjusting a selector for enabling deflating air from all of the cushion chambers, and deflating air from all of the cushion chambers (stage 1301).

Note: the fluid source must provide air, or another fluid at a sufficiently high pressure for each cushion chamber to be able to inflate to its maximum volume while there is a disabled user seated on the cushion, whose maximum weight is defined in the specifications of the assisting system.

While the invention has been described with respect to a limited number of embodiments, it will be appreciated that many variations, modifications and other applications of the invention may be made.

What is claimed is:

1. A method of an operation of an assisting system, wherein said assisting system includes a cushion, wherein said cushion includes n-cushion chambers, the method comprising the stages of:
checking pressure measured by a pressure sensor;
if at the pressure checking stage, said pressure, measured by said pressure sensor, is at least equal to a predetermined value, performing a sub-stage of sequential deflating of said cushion chambers; and
if at the pressure checking stage, said pressure, measured by said pressure sensor, is lower than said predetermined value, performing a sub-stage of sequential inflating of said cushion chambers system.

2. The method of claim 1, wherein the sub-stage of sequential deflating of said cushion chambers includes:
adjusting a selector of said assisting system for enabling deflating air from a first selected cushion chamber, and deflating air from said first selected cushion chamber;
measuring predetermined period of time; and
adjusting said selector for enabling deflating air from a second selected cushion chamber, and deflating air from said second selected chamber.

3. The method of claim 1, wherein the sub-stage of sequential deflating of said cushion chambers includes:
adjusting a selector of said assisting system for enabling deflating air from a first selected cushion chamber, and deflating air from said first selected cushion chamber;
measuring said pressure measured by a pressure sensor; and
if said pressure, measured by said pressure sensor, is at most equal to an atmospheric pressure, adjusting said selector for enabling deflating air from a second selected cushion chamber, and deflating air from said second selected chamber.

4. The method of claim 2, wherein said first selected cushion chamber is a most upper cushion chamber.

5. The method of claim 2, wherein the sub-stage of sequential deflating of said cushion chambers further includes:
if n is larger than two, measuring predetermined period of time; and
adjusting said selector for enabling deflating air from a third selected cushion chamber, and deflating air from said third selected chamber.

6. The method of claim 1, wherein the sub-stage of sequential inflating of said cushion chambers includes:
adjusting a selector of said assisting system for enabling inflating a first selected cushion chamber;
supplying air from a high pressure source and inflating said first selected cushion chamber;
measuring predetermined pressure by said pressure sensor;
adjusting said selector of said assisting system for enabling inflating a second selected cushion chamber; and
supplying air from a high pressure source and inflating said second selected cushion chamber.

7. The method of claim 6, wherein the sub-stage of sequential inflating of said cushion chambers further includes:
if n is larger than two, measuring predetermined period of time;
measuring predetermined pressure by said pressure sensor;
adjusting said selector for enabling inflating a third selected cushion chamber; and
supplying air from a high pressure source and inflating said third selected cushion chamber.

8. The method of claim 1 further includes:
after performing a sub-stage of sequential deflating of said cushion chambers, activating a control device; and
performing a sub-stage of sequential inflating.

9. The method of claim 1 further includes:
after performing a sub-stage of sequential inflating of said cushion chambers, activating a control device; and
performing a sub-stage of sequential deflating.

10. A method of an operation of an assisting system, wherein said assisting system includes a cushion, wherein said cushion includes n-cushion chambers, said method comprising the stages of:
activating said assisting system;
adjusting a selector of said assisting system, for enabling deflating air from all of said n-cushion chambers, and deflating air from all of the cushion chambers; and
performing a parallel inflating.

11. An assisting system for assistance of a person requiring assistance in transition such as between standing and sitting, the assisting system comprising:
a cushion, wherein said cushion includes n-cushion chambers, wherein said n is an integer number, larger than one, wherein said n-cushion chambers are disposed one above the other, and every two subsequent cushion chambers, of said n-cushion chambers, are attached to each other, wherein each one of said n-cushion chambers has a chamber wall and a chamber opening, wherein said chamber walls include no opening that enable a direct movement of fluid between one of said n-cushion chambers to another one of said n-cushion chambers;
a selector, wherein said selector includes;
n-selector openings, wherein each one of said n-selector openings is operatively connected to one, and only to one, of said chamber openings, for enabling a fluid flow from said selector into said one chamber opening; and
a selector inlet for enabling a fluid flow into said selector; and
a fluid source operatively connected to said inlet, for enabling a fluid flow from said fluid source into said selector.

12. The assisting system of claim 11, wherein said selector is adapted to enable performing a full sequential deflating of said n-cushion chambers, activated by at least one command signal.

13. The assisting system of claim 11, wherein said selector is adapted to enable performing a partial sequential deflating of said n-cushion chambers, activated by one command signal.

14. The assisting system of claim 11, wherein said selector is adapted to enable performing a deflating of one selected cushion chamber from said n-cushion chambers for each command signal.

15. The assisting system of claim 11, wherein said selector is adapted to enable performing a parallel inflating of said n-cushion chambers.

16. The assisting system of claim 13, wherein said selector is further adapted to enable performing a full sequential inflating of said n-cushion chambers, activated by one command signal.

17. The assisting system of claim 11, wherein inside of at least one of said n-cushion chambers there is a porous layer.

18. The assisting system of claim 11 further comprising:
an outer cover, coating said cushion wherein said outer cover is composed of elastic material.

19. The assisting system of claim 11 further comprising:
n-selector tubes, wherein each one of said n-selector tubes is disposed between one of said n-selector openings and one of chamber openings.

20. The assisting system of claim 11 further comprising:
a source tube disposed between said fluid source and said selector inlet; and
a pressure sensor located on the source tube.

21. The assisting system of claim 11 further comprising:
a control device; and
an electrical wire disposed between said fluid source and said control device.

22. The assisting system of claim 11 wherein said selector further includes:
an upper cover wherein said selector openings are located at said upper cover;
a front housing having n-front housing slots, wherein said front housing is disposed on said upper cover;
a selector inlet located at said front housing;
a rear housing having n-rear housing slots, wherein said rear housing is disposed on said upper cover and on said front housing;
a seal cylinder mounted inside said front housing and said rear housing, wherein said seal cylinder have a selector cylinder wall, wherein there is n-seal cylinder slots at said selector cylinder wall; and
a selector cylinder mounted inside said seal cylinder, wherein said selector cylinder have a selector cylinder wall, having a selector cylinder rear side, and a selector cylinder front side, wherein a selector cylinder rear wall, is disposed on said selector cylinder wall at said selector cylinder rear side, wherein there is a selector cylinder front opening, located at said selector cylinder front side, wherein there are a selector cylinder side opening, and a selector cylinder upper opening, at said selector cylinder wall.

23. The assisting system of claim 22 wherein said selector further includes:
a rotational axle, mechanically connected to said selector cylinder;
an engine, mechanically connected to said rotational axle;
a positioning disc, having a positioning disc concave and a positioning disc projection, said positioning disc is mechanically connected to said rotational axle; and
a micro switch having a micro switch spring, at the end of which there is a micro switch wheel, wherein said micro switch wheel is in contact with said positioning disc.
